(19) United States
(12) Patent Application Publication
(10) Pub. No.: US 2015/0101406 A1
(43) Pub. Date: Apr. 16, 2015

(54) REAL-TIME LEVEL MONITORING FOR FIXED BED CATALYST LOADING USING MULTIPLE LEVEL SENSORS

(71) Applicants: YI EN HUANG, North Potomac, MD (US); David C. Dankworth, Great Falls, VA (US); Keith Wilson, Weybridge (GB); Manuel S. Alvarez, Warrenton, VA (US); Rathna P. Davuluri, Fairfax, VA (US); Jeffrey W. Frederick, Upper Black Eddy, PA (US); Bryan A. Patel, Jersey City, NJ (US)

(72) Inventors: YI EN HUANG, North Potomac, MD (US); David C. Dankworth, Great Falls, VA (US); Keith Wilson, Weybridge (GB); Manuel S. Alvarez, Warrenton, VA (US); Rathna P. Davuluri, Fairfax, VA (US); Jeffrey W. Frederick, Upper Black Eddy, PA (US); Bryan A. Patel, Jersey City, NJ (US)

(73) Assignee: ExxonMobil Research and Engineering Company, Annandale, NJ (US)

(21) Appl. No.: 14/485,834

(22) Filed: Sep. 15, 2014

Related U.S. Application Data
(60) Provisional application No. 61/891,569, filed on Oct. 16, 2013.

(51) Int. Cl. G01F 23/28; G01F 23/296; G01F 23/284

(52) U.S. Cl. CPC G01F 23/28; G01F 23/284; G01F 23/296
USPC 73/290 V; 73/290 R

(57) ABSTRACT

In various aspects, methods and systems are provided for monitoring catalyst bed levels using multiple sensors that are temporarily installed in a reactor during catalyst loading. The multiple sensors are able to take distance measurements at substantially the same time and at predetermined time intervals so as to provide a catalyst time profile. The catalyst time profile allows an operator monitor catalyst levels during and after catalyst loading. Once catalyst loading is completed, the multiple sensors are removed from the reactor.

### CROSS-REFERENCE TO RELATED APPLICATIONS

This application is a non-provisional application which claims the benefit of priority of Provisional Application U.S. Ser. No. 61/891,569 filed on Oct. 16, 2013, the entirety of which is incorporated herein by reference.

### FIELD

Systems and methods are provided for real-time monitoring of catalyst loading using multiple level sensors.

### BACKGROUND

Catalytic fixed bed reactors have been utilized for many decades in the petroleum and petrochemical refining industry (i.e., the “industry”) for upgrading raw or intermediate petroleum-based feedstocks into more valuable fuel and chemical products and base stocks. Chemicals reactors have diameters usually not more than 10 ft, typically 2 to 6 ft; refining hydroprocessing reactors have diameter up to 22 to 24 ft, typically 8 to 18 ft.

There are three types of catalyst loading processes that are the standards of the industry. These three processes include “dump loading” where catalyst is dumped into the reactor, “sock loading” where a flexible hose is manually moved around the internal catalyst bed as catalyst is being fed through the hose, and “dense loading” where a rotary device sprays the catalyst in a radial pattern into the catalyst bed during loading. Typically, an even or level catalyst bed is desired to ensure even flow distribution in the reactor during catalytic processing.

U.S. Pat. No. 8,217,831 generally describes a transmitter used in a reactor for transmitting a signal to various points on a surface for determining a distance between the transmitter and the points on the surface. The single transmitter is shifted to different locations in the reactor to take distance measurements at different locations.

### SUMMARY

One aspect of the invention relates to a method for monitoring catalyst levels during catalyst loading of a catalyst bed in a reactor, the method comprising;
removably coupling a plurality of sensors to an interior structure of a reactor;
during catalyst loading of a catalyst bed in the reactor, detecting catalyst levels in the catalyst bed at multiple locations by the plurality of sensors at substantially a same time;
based on the detected catalyst levels, identifying non-uniformity of a catalyst level in the catalyst bed; and
modifying at least one condition based on the identified non-uniformity, the condition corresponding to a reaction condition for catalytic processing in the reactor, a loading condition for catalyst loading in the reactor, or a combination thereof.

In one embodiment, data is transmitted from each of the plurality of sensors to a monitoring station after each of the predetermined time intervals so that the data is monitored in real-time.

In another embodiment, the at least one reaction condition of the catalytic processing in the reactor comprises a space velocity of feedstock in the reactor, a hydrogen partial pressure in the reactor, an operating temperature of the reactor, or a combination thereof. Further, in one embodiment, the at least one loading condition is a flow rate of the catalyst, an angle at which the catalyst is loaded into the reactor, a position of a catalyst loading device, or a combination thereof.

In yet another embodiment, a catalyst level profile is generated that provides data received from the plurality of sensors over a period of time.

Another aspect of the invention relates to a system for detecting catalyst levels during catalyst loading of a catalyst bed in a reactor, the system comprising:

a modular sensor array comprising:
a plurality of sensors for measuring catalyst levels at multiple locations in a catalyst bed in a reactor at substantially a same time and at predetermined time intervals during catalyst loading, each of the plurality of sensors comprising a transceiver for transmitting catalyst level data to a monitoring station; and
a support structure secured to the plurality of sensors, the support structure being removably coupled to an interior structure of the reactor to allow the support structure and the plurality of sensors to be removed from the reactor during catalytic processing.

### BRIEF DESCRIPTION OF THE DRAWINGS

FIG. 1 schematically shows an example of a configuration suitable for monitoring catalyst levels during catalyst loading of catalyst bed in a reactor for performing catalytic processing.

FIG. 2 shows an example of the level sensors in a linear cross pattern.

FIG. 3 shows an example of the level sensors in a concentric circular pattern.

FIGS. 4-8 are graphs illustrating a minimum time interval of taking samples at various reactor diameters for different bed rise rates.

### DETAILED DESCRIPTION

In various aspects, catalyst levels at different locations of catalyst bed in a reactor can be measured by multiple sensors simultaneously or at substantially the same time. This provides an accurate indication of the levelness of the catalyst bed at the time when the measurements are taken by the multiple sensors. Measurement using a plurality of removably attached sensors allows for detection of catalyst level during catalyst loading, rather than having to pause the catalyst loading process to allow for a visual inspection. Additionally, different locations can be sampled at the same or similar times, in contrast to attempting to use a single sensor to detect catalyst levels in a reactor. The sensors are secured to a temporary support bracket that is coupled to an interior structure of the reactor during catalyst loading, after which it is removed during catalytic processing. The multiple sensors may be removably coupled to the inside of the reactor in a particular pattern, such as a linear cross pattern or a concentric circular pattern, for example. The sensors may be any type of sensor that is able to detect a catalyst level measurement, such as radar, ultrasonic, sonar, or nuclear sensors.

The multiple sensors or at least a portion thereof may detect catalyst levels at predetermined time intervals to generate a catalyst level profile over a given time period. As a result of an operator having multiple catalyst level measurements at different locations on a catalyst bed that were taken simultaneously or at least at substantially the same time, the operator is able to make adjustments to the catalyst loading or reactor conditions during catalytic processing. For example, the flow rate of the feedstock or operating conditions of the reactor may be adjusted to compensate for the uneven catalyst bed. Additionally or alternatively, the flow rate of the catalyst, the angle at which the catalyst is loaded into the reactor, or a position of the catalyst loading device may be modified to compensate for the uneven catalyst bed.

A time interval, or a period of time needed to catch a particular formation on the catalyst bed, may be determined based on one of many factors, including a bed rise rate, the reactor diameter, or the formation of the catalyst on the catalyst bed, such as a dish, dome, wave, or sloped formation. Once the sampling interval is determined, a sampling frequency may then be determined, which indicates how frequently a sample or measurement of the catalyst bed level is to be taken. From the sampling frequency, the sampling interval rate can be determined, indicating how many samples are to be taken in a certain period of time (e.g., per minute or per hour).

All numerical values within the detailed description and the claims herein are modified by “about” or “approximately” the indicated value, and take into account experimental error and variations that would be expected by a person having ordinary skill in the art.

The term “substantially the same time” refers to the ability to obtain data at a plurality of locations using multiple sensors at times that differ from each other by less than a threshold amount of time, such as less than about one minute, less than thirty seconds, less than fifteen seconds, less than ten seconds, less than five seconds, less than one second, or less than 0.5 seconds. For example, in one embodiment, multiple sensors may each obtain catalyst level data at times that differ from each other by less than 0.5 seconds, where the data is taken from a plurality of different locations on the catalyst bed. By obtaining a plurality of catalyst levels at different locations at substantially the same time, a catalyst level profile can also be generated for subsequent analysis.

As previously mentioned, in the petroleum and petrochemical refining industry, three main methods have been utilized for catalyst loading of catalyst beds in these large fixed bed reactors as described and are both well known to those of skill in the art. The first method can be typically referred to as the “dump loading” method. Here, the catalyst is simply dumped into the reactor (by such devices as individual catalyst containers or buckets). Here, if the vessel is large enough, an internal worker may (not required) be located in the vessel during catalyst loading and/or after the catalyst loading is complete to assist in distributing the catalyst within the vessel. The second method is typically referred to in the industry as a catalyst “sock loading” method. In this method a flexible hose (i.e., the “sock”) is connected to the catalyst hopper and down into the reactor where a worker moves the outlet line of the hose around the internal catalyst bed as the catalyst is being fed through the hose attempting to achieve a consistent and uniform loading of the catalyst in the bed (i.e., to reduce voidages and inconsistencies, such as “bridging”, in the installed catalyst bed). The term “voidage” as used herein, is a standard term of the art measuring the percentage of void space (i.e., space no occupied by the catalyst) per unit volume in a catalyst bed. The term “packing density” as used herein, is a standard term of the art measuring the density of the catalyst per unit volume in a catalyst bed.

The third method for catalyst loading of these large catalyst bed reactors has been utilized which is called “dense loading” (or “dense bed loading”). Here, a rotary device which is temporary located in the reactor during the catalyst loading process, is utilized which obtains a feed of catalyst from the catalyst hopper, and essentially sprays the catalyst in a radial pattern into the catalyst bed during loading. The underlying principal with this process is that the catalyst (typically a uniform diameter, extrudated catalyst with an L/D ratio of greater than one) will uniformly directionally orient and distribute within the catalyst bed, thereby reducing inconsistencies and voidages. It has been noted in the industry that the “dense loading” process typically results in a catalyst bed loading that has a final voidage that is a few percentage points less than the voidage obtained by using either the “dump loading” or “sock loading” methods.

However, what has been discovered herein is that even with the most current and advanced dense loading technologies, inefficient and non-uniform operation in commercial hydroprocessing reactors often occurs. It has been identified that an uneven or unlevel catalyst loading will lead to flow maldistribution and poor performance of the reactor. However, the current commercial practice does not give an accurate representation of the bed levelness, and is also time consuming.

These three processes are the standards of the industry with the most homogeneous and dense large vertical catalyst bed loading typically achieved via the dense loading process as described.

What has been discovered herein is that even the catalyst dense loading process often results in inefficient and non-uniform operations in commercial hydroprocessing reactors. Uneven flow distribution in the reactors may cause many problems, including lost catalytic conversion and selectivity efficiencies, safety problems (such as reactor hot spots than can lead to temperature runaway), shortened catalyst life, and off-specification products from the catalytic reactions. These problems associated with poor catalyst bed loading can cost refiners millions of dollars a year in lost profits, as well as contribute to unscheduled process/equipment outages and/or safety incidents. As can be seen, due to these high potential costs/losses, refiners typically pay a premium to have catalyst beds loaded via the dense catalyst loading method over the sock catalyst loading methods just to achieve marginally higher (denser) and more uniform loading of the catalyst in the beds of the reactors. However, the inventors herein have found that many commercial reactors, even when catalyst loaded via the dense catalyst loading method, can experience significant flow maldistribution during operation, again resulting in significant lost profits as have been described. When maldistribution is determined, dense loading may be adjusted by one of a number of methods, including, for example, rotational speed (changes the projectile angle), catalyst flow rates to different annular zones, position of the loading device, and direction of rotation (e.g., clockwise, counterclockwise).

In order to ensure levelness during dense loading, the dense loading machine is stopped regularly to measure the levelness. Levelness may be gauged or assessed by video inspection, using a tape measure at various points, etc., and may even require vessel entry by an operator. Some commercial practices may even infer the levelness by comparing the actual packing density to the expected packing density. While a single sensor may be used to provide a levelness measurement during dense loading, catalyst loading has to be interrupted and stopped before levelness can be measure if measurements are taken manually where an operator is involved, and having only one level sensor takes much more time to measure the levelness across the entire reactor bed surface, especially for a large reactor.

There are various issues associated with catalyst level measurement for small reactors. For instance, for very small reactors, an operator may not even be able to fit inside the reactor, which makes visual inspection difficult. Additionally, the only way to visually inspect the catalyst level is to interrupt catalyst loading periodically and wait for the dust to settle. This is time consuming and can be inaccurate. For larger reactors, as previously mentioned, while an operator may be able to access the inside of the reactor by way of a manway, for example, manually measuring the catalyst level at different locations within the reactor is time consuming, and like small reactors, catalyst loading is interrupted. Even if the operator uses a sensor to take these measurements, the sensor has to be moved or rotated to different locations inside of the reactor such that the measurements at different locations of the catalyst bed are not taken simultaneously or even at substantially the same time. The methods and systems described herein in relation to real-time monitoring of catalyst levels during catalyst loading provide numerous benefits when used in both small reactors and large reactors.

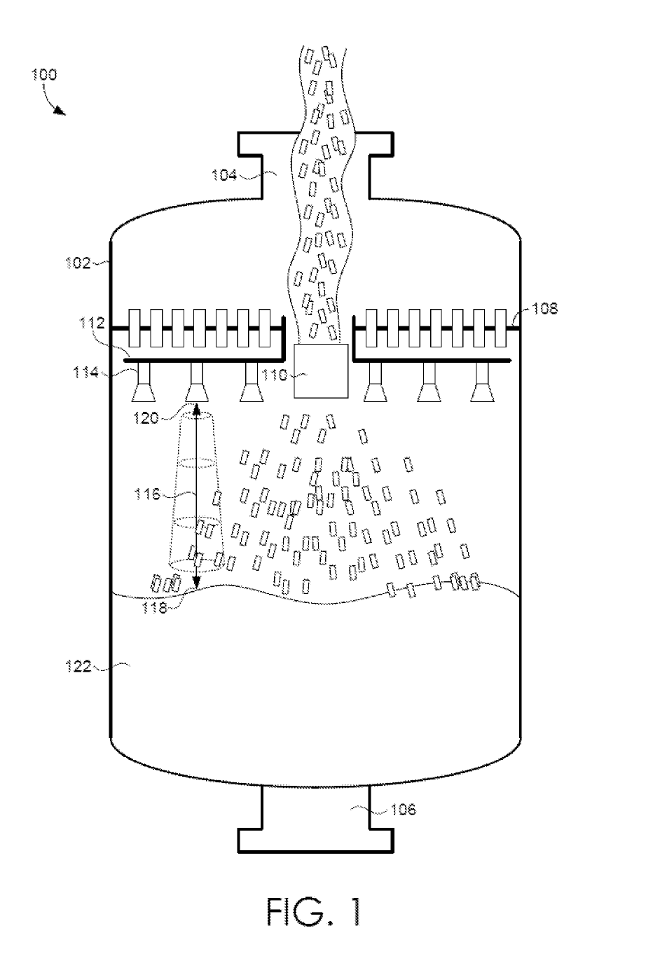

To illustrate an exemplary configuration suitable for monitoring catalyst levels during catalyst loading of a catalyst bed in a reactor, FIG. 1 is provided. FIG. 1 illustrates a reactor 102 having an inlet opening 104 and an outlet opening 106. Distributor plate 108, in one embodiment, occupies a full cross section of the reactor but has a plurality of holes in it that allow for the feedstock liquid to distribute into the reactor. In one embodiment, the distributor plate 108 is a permanent structure inside of the reactor. In addition to the plurality of in the distributor plate 108, the distributor plate 108 typically has a plate (e.g., located in the center of the distributor plate 108) that opens or is removable that allows for catalyst loading. During catalyst loading, catalyst enters the reactor 102 through the inlet opening 104 and is distributed into the reactor by way of a catalyst loading machine 110. As mentioned, there are at least three methods of catalyst loading, including dump loading, sock loading, and dense loading, and as such, the catalyst loading machine used may be determined by the preferred catalyst loading method. In some embodiments, a catalyst loading machine may not be used at all, and instead the catalyst may be dumped into the reactor and distributed manually. The catalyst bed is illustrated by item 122.

The temporary support bracket 112 may be removably coupled to an internal structure of the reactor, such as the distributor plate 108. In other embodiments, the temporary support bracket 112 may be removably coupled to another internal structure, such as catalyst bed support beams, internal structural support rings, vessel flanges, or vessel manways. The sensors 114 are secured to the temporary support bracket 112. The quantity of sensors used in a reactor may depend on various factors, including the size of the reactor, the method of catalyst loading being used, the configuration of the sensors, etc. For instance, a larger reactor would naturally have a need for a larger quantity of sensors than a smaller reactor so that the catalyst level could be determined at many locations on the catalyst bed. Also, certain types of catalyst loading techniques are known to produce a more level catalyst bed, and as such fewer sensors may be needed in those instances. Optionally but preferably, the sensors are removably mounted at fixed locations above a catalyst bed so that the sensors do not translate or otherwise move to new locations parallel to the surface of the catalyst bed during a catalyst loading procedure. This allows the sensors to sample the catalyst level at the same location(s) during a given catalyst loading procedure.

Each sensor 114 is able to measure a distance 116 between the sensor 120 and the top of the catalyst bed 118. The type of sensor used may be radar, sonar, ultrasonic, nuclear, or any other type that allows for a wave to be sent to the top of the catalyst bed. The wave is bounced off of the top of the catalyst bed, and the time it takes for the wave to return to the sensor indicates a distance between the top level of the catalyst bed and the sensor. In one embodiment, the sensors include a transmitter for transmitting data from the sensor 114 to a computing device. In one embodiment, the data is sent to a monitoring station, which may include a computing device where the data can be stored and viewed by an operator, for example. The transmitter may also include a receiver for receiving instructions from the monitoring station or elsewhere, such as when to detect catalyst levels in the reactor. As mentioned, catalyst levels may be detected during catalyst loading at predetermined intervals of time at a given sampling interval rate, which may depend on the reactor diameter, the formation or type of unevenness on the catalyst bed, or the bed rise rate.

The plurality of sensors utilized in a single reactor may each send a signal at each of the predetermined intervals of time so that multiple distance measurements are obtained at each interval of time. Each interval of time may be referred to as a sampling frequency, such that is a sample or measurement is to be taken every five seconds, the interval of time is five seconds, and the sampling interval rate is 12 samples per minute. Furthermore, if the predetermined interval of time is one minute, the plurality of sensors each take a distance measurement every one minute at their respective location by sending a wave that bounces off the top of the catalyst bed, which can be used to determine a distance between the sensor and the top of the catalyst bed in a dusty environment while catalyst loading is in progress. Because multiple sensors are utilized, multiple measurements are obtained simultaneously or at least at substantially the same time at different locations on the catalyst bed. The sensors are able to take a sampling of the distance from the sensor down to the catalyst bed at different locations at the same time. This indicates to the operator where the high and low levels on the catalyst bed are located so that adjustments can be made to compensate for the unevenness of the catalyst bed. While conventionally, multiple catalyst level measurements cannot be taken at substantially the same time because of the traditional use of visual inspection or a single sensor that is rotated in the reactor over a period of time, the use of multiple sensors taking measurements at substantially the same time allows the operator to efficiently determine how to adjust the catalyst loading and/or the catalyst processing conditions to compensate for the uneven catalyst bed.

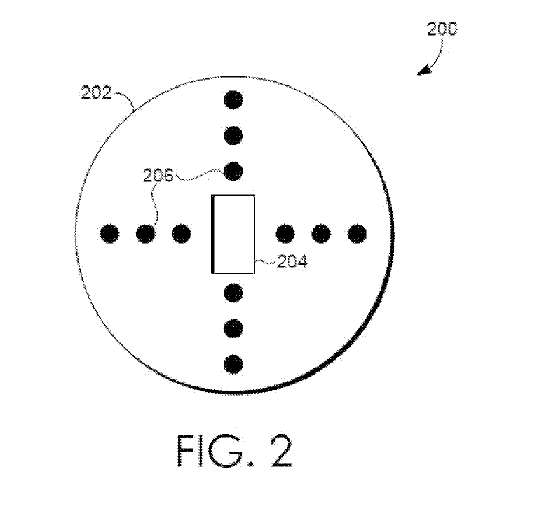

FIG. 2 illustrates a cross-sectional view 200 of a reactor 202 that has a plurality of sensors 206 positioned in a linear cross pattern. In the embodiment of FIG. 2, multiple sensors 206 are positioned across the reactor diameter, with another row of sensors 206 perpendicular to that row. As such, a linear cross pattern is obtained. The sensors, secured to a temporary support bracket, are installed through an opening 204 in the distribution plate, for example, in the reactor prior to catalyst loading. During catalyst loading, these sensors are able to provide immediate feedback on the catalyst bed level at the point beneath each sensor. A catalyst level profile can then be generated to provide the catalyst loading operators with a real-time feedback for improved monitor and control.

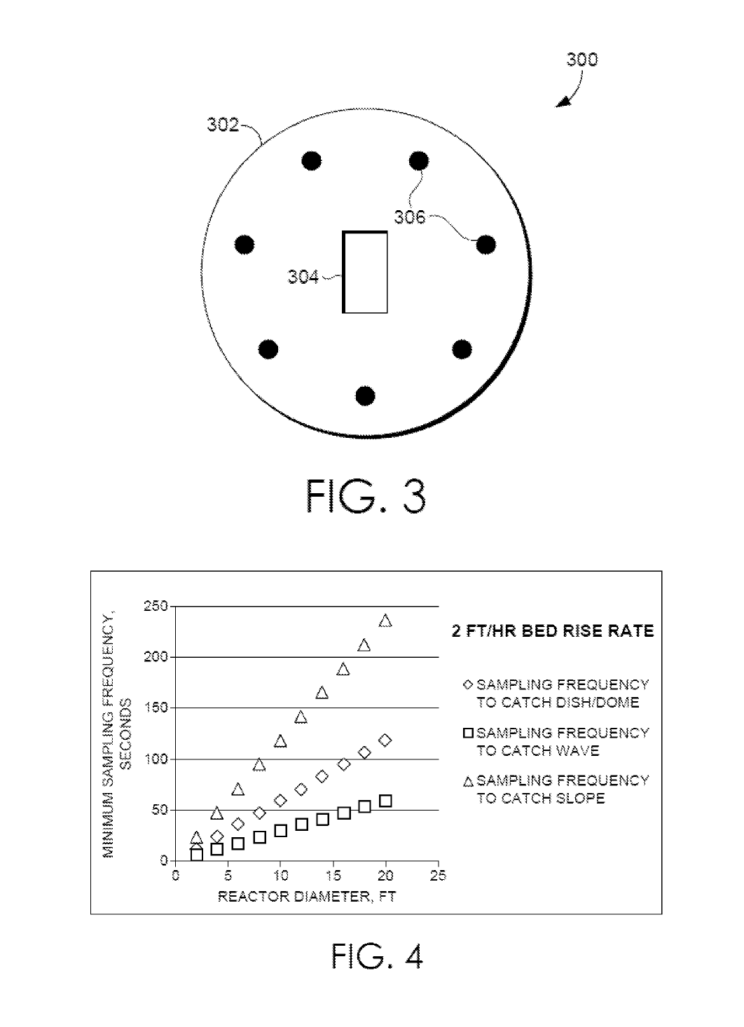

While FIG. 2 illustrates the plurality of sensors in a linear cross pattern, FIG. 3 illustrates a plurality of sensors 306 in a concentric circular pattern. In particular, FIG. 3 illustrates a cross-sectional view 300 of a reactor 302 having a plurality of sensors positioned in a concentric circular pattern. The plurality of sensors 306 are secured to a temporary support bracket so that the entire sensor structure (plurality of sensors 306 and the temporary support bracket) can be installed in the reactor, such as through an opening 304 in the distribution plate, for example, prior to catalyst loading, and then removed once loading is finished. While a linear cross pattern and a concentric circular pattern of sensors are illustrated in FIGS. 2 and 3, other patterns of sensors are contemplated to be within the scope of the present invention, although no shown in a figure. The exact pattern of sensors may differ, as long as multiple locations on the catalyst bed are monitored for levelness by multiple sensors.

As previously mentioned, the plurality of sensors in a single reactor may each take measurements at predetermined intervals of time, or at a specified sampling frequency. As a uniform and even catalyst bed is desired for enhanced performance of the reactor, unevenness of the catalyst bed during catalyst loading should be caught quickly. Unevenness of the catalyst bed could take the form of a dish formation, a dome formation, waves, slopes, etc. For instance, in one embodiment, it is desired to keep the angle or unevenness of the catalyst bed at less than three degrees from the horizontal. To prevent unevenness of the catalyst bed, measurements or samples are taken frequently to catch unevenness so that it can be corrected.

The time interval required to catch a particular type of unevenness on the catalyst bed and the sampling interval rate at which measurements are taken may vary based on one or more factors, including the bed rise rate, the reactor diameter, and the type of formation or unevenness of the catalyst bed (e.g., dish shape, a dome shape, wave formations, slopes). As used herein, the time interval is an amount of time required to catch a particular type of unevenness, which is typically provided in seconds. The sampling interval rate (typically samples per minute) is the rate at which samples are taken so that the particular formation or unevenness on the catalyst bed can be caught. In one embodiment, the time interval required to catch a slope formation on the catalyst bed is greater than that required to catch a wave, dish, or dome formation on the catalyst bed. To catch any formation on a catalyst bed, the sampling interval rate may be at least about 3 samples/min, at least about 5 samples/min, at least about 10 samples/min, at least about 15 samples/min, at least about 20 samples/min, at least about 30 samples/min, or at least about 60 samples/min. As an example, the sampling interval rate may be less than about 1000 samples/min.

As mentioned, samples may be taken more frequently to catch a wave formation on the catalyst bed, and less frequently taken to catch a slope formation on the catalyst bed. For instance, to catch a wave formation, the sampling interval rate may be at least about 60 samples/min for at least about 5 seconds for a reactor having a small diameter (e.g., 2-4 feet) and a bed rise rate of about 20 ft/hr, but at least about 11 samples/min for at least 47 seconds for a reactor having a larger diameter (e.g., 20 feet) at the same or similar bed rise rate. Similarly, to catch a slope formation on the catalyst bed, the sampling interval rate may be at least about 30 samples/minute for at least about 19 seconds for a reactor having a small diameter (e.g., 2 feet) and a bed rise rate of about 20 ft/hr, but at least about 3 samples/min for at least about 189 seconds for a reactor having a larger diameter (e.g., 20 feet) and the same or similar bed rise rate. Table 1 below illustrates exemplary time intervals and sampling rates for various formations for different reactor diameters where the reactor has a bed rise rate of 20 feet per hour.

TABLE 1
Time Intervals and Sampling Interval Rates for
Various Formations at a Bed Rise Rate of 20 ft/hr

| Reactor Diameter (ft) | 2 | 8 | 14 | 20 |
|---|---|---|---|---|
| Dish/Dome | | | | |
| Time Interval to Catch | 9 | 38 | 66 | 94 |
| Unevenness (sec) | | | | |
| Sampling Interval Rate | 60 | 12 | 8 | 5 |
| (Samples/Minute) | | | | |
| Wave (Less than 3 degrees) | | | | |
| Time Interval to Catch | 5 | 19 | 33 | 47 |
| Unevenness (sec) | | | | |
| Sampling Interval Rate | 60 | 30 | 15 | 10 |
| (Samples/Minute) | | | | |
| Slope (Less than 3 degrees) | | | | |
| Time interval to Catch | 19 | 75 | 132 | 189 |
| Unevenness (sec) | | | | |
| Sampling Interval Rate | 30 | 7 | 4 | 3 |
| (Samples/Minute) | | | | |

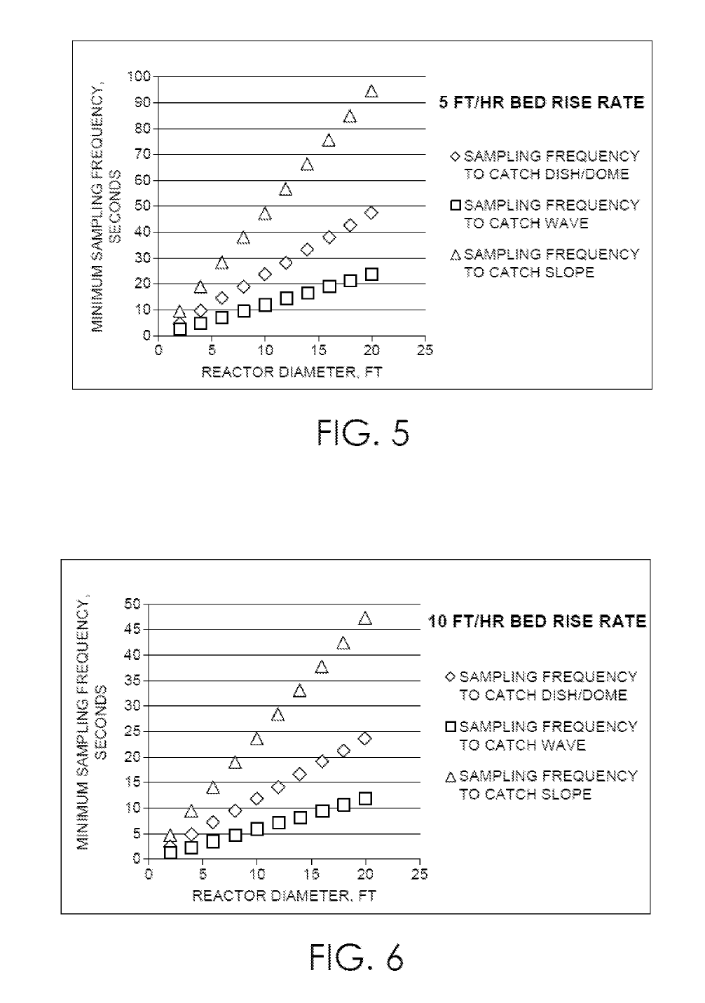

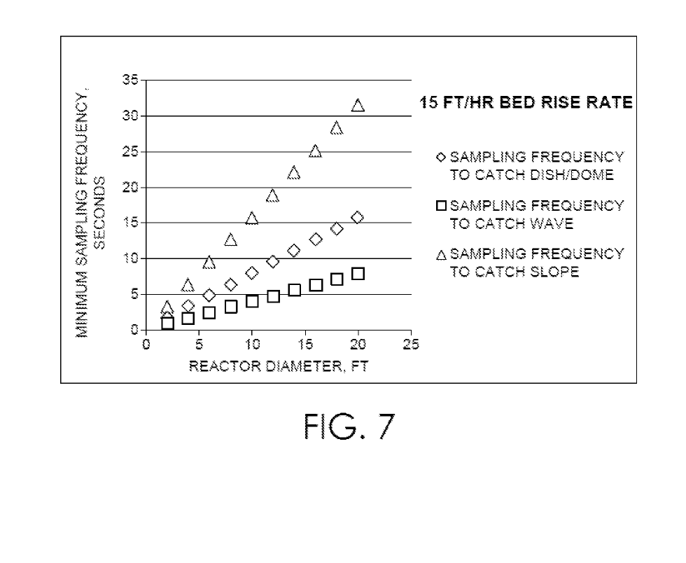

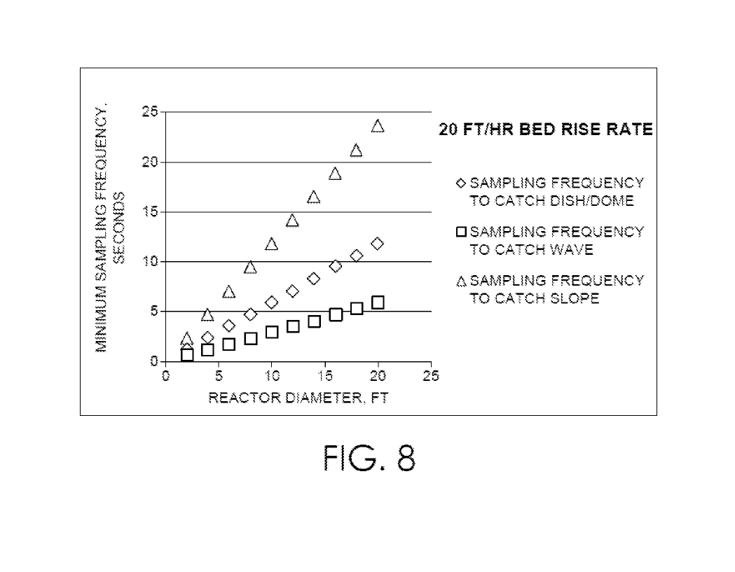

FIGS. 4-8 are graphs illustrating the minimum time (in seconds) between samples that is required to catch either a dish/dome formation, a wave formation, or a slope formation on a catalyst bed based on the reactor diameter (in feet) at a particular bed rise rate. FIG. 4 is for a bed rise rate of 2 ft/hr, FIG. 5 is for a bed rise rate of 5 ft/hr, FIG. 6 is for a bed rise rate of 10 ft/hr, FIG. 7 is for a bed rise rate of 15 ft/hr, and FIG. 8 is for a bed rise rate of 20 ft/hr. As shown, as the bed rise rate increases, the time between samples required to catch a particular type of unevenness on the catalyst bed decreases.

As mentioned above, multiple sensors may take samples at substantially the same time, such as less than about one minute, less than thirty seconds, less than fifteen seconds, less than ten seconds, less than five seconds, less than one second, or less than 0.5 seconds. The sampling interval rates discussed above are thus correlated to the timing of the multiple sensors taking samples such that if the sampling interval rate of each of the sensors is 4 samples/minute, or a sample every 15 seconds, the time difference between a first sensor taking a sample and a second sensor taking a sample would be less than 15 seconds, and likely even less than that. This can be contrasted to the use of only a single sensor in a reactor, where this sensor would not be able to take samples of various locations in the reactor at substantially the same time, but instead would only be capable of taking one sample at a time.

The data obtained from the distance measurements may then be sent by the transmitters to the monitoring station for evaluation. As a plurality of sensors are utilized in a single reactor, the need to rotate a sensor around the reactor is eliminated, thus reducing the time required to take catalyst level measurements during catalyst loading. Also eliminated is the need for operator interaction in the catalyst level detection process, and specifically for taking the measurements and moving sensors around within the reactor.

The use of multiple sensors that each provide a catalyst bed level measurement at each of the multiple sensor's respective location on the catalyst bed at predetermined intervals of time allows for a catalyst level profile to be generated over a period of time. For instance, each sensor may detect a catalyst bed level at substantially the same time. At this time, if there are twelve sensors, twelve catalyst bed level measurements are taken at every predetermined interval of time. The profile may then illustrate the catalyst bed level at twelve locations at every predetermined interval of time. This allows an operator to monitor the level of the catalyst bed during catalyst loading and in real-time without interruption of catalyst loading. If an operator chooses to analyze the catalyst time profile after catalyst loading to determine how to modify catalytic processing conditions in the reactor, the operator will have catalyst bed level measurements from the entire period of time of catalyst loading. Alternatively, if an operator chooses to analyze the catalyst time profile during catalyst loading, the operator will have catalyst bed level measurements since the start of catalyst loading, which can allow the operator to modify catalyst loading. For instance, catalyst loading may be modified by changing the flow rate of the catalyst, altering the angle at which the catalyst is loaded into the reactor, or adjusting the position of the catalyst loading device during catalyst loading. Using conventional (visual) methods for taking catalyst bed level measurements, the measurement process typically interrupts catalyst loading. This is in part due to the need to wait for catalyst dust in the reactor to settle. By contrast, having multiple sensors temporarily installed in the reactor eliminates the interruption of catalyst loading.

While in one embodiment all sensors in the reactor take catalyst level measurements at substantially the same time and at predefined time intervals, in an alternative embodiment, a portion or a combination of the sensors in the reactor take catalyst level measurements at substantially the same time. For instance, for a given time period, two sensors, a plurality of sensors, nearly all of the sensors, or all of the sensors are used to take catalyst level measurements in the reactor. Some combination of the sensors arranged in a particular pattern (e.g., linear cross pattern, concentric circular pattern), for instance, may be utilized for a particular sampling period. The same combination or portion of sensors may be used for multiple, consecutive sampling intervals, or a different combination or portion of sensors may be used. For example, the sensors used for a first sampling time may be modified for the subsequent sampling time. In this example, the sensors used may be alternated between sampling times so that different sensors are used in consecutive samplings. The pattern of sensors used to sample the distance from the sensors to the catalyst bed may also be alternated so that, for example, a first pattern of sensors is used at a first sampling time while a second pattern of sensors is used at a second sampling time.

As mentioned, there are many advantages to the use of a plurality of sensors that are removably installed in a reactor prior to catalyst loading and removed after catalyst loading. For instance, real-time feedback can be provided to the different methods of catalyst loading, including dense loading, to better improve or optimize the catalyst loading process. Further, catalyst loading is improved by reducing the need for an operator to enter the reactor during catalyst loading and by reducing the need to interrupt catalyst loading to check catalyst levels at multiple locations on the catalyst bed. Also, as mentioned, an uneven catalyst bed can lead to multiple problems, including flow maldistribution and poor performance on the unit. By using multiple sensors that are removably installed in the reactor, uneven catalyst loading can be detected earlier, and thus can be corrected earlier.

One benefit of detecting catalyst level while loading is in progress is that the catalyst loading conditions can be modified during loading to reduce or mitigate the impact of uneven loading of the catalyst bed. In some aspects, the ability to even out the catalyst bed height at an intermediate time during loading can reduce or minimize the likelihood of having a subsequent problem during a process using the catalyst bed. Thus, modifying the catalyst loading process during loading can in some aspects avoid the need to modify the process conditions used within the reactor.

Additionally or alternately, a knowledge or expectation of non-uniform catalyst loading can be used to select modified operating conditions and/or to interpret operating data for a reactor. Although the catalyst level is being detected during catalyst loading, the operator may not be able to identify that an undesirable loading condition is occurring during the loading process. Instead, the undesirable loading condition may only be apparent after subsequent analysis of the catalyst level data gathered by the plurality of sensors at the various catalyst bed locations. Alternatively, even if the operator detects an undesirable loading condition, the attempts to correct the catalyst height may be only partially effective. In either event, the catalyst level data obtained by the plurality of sensors can indicate one or more potential problems with the condition of a loaded catalyst bed. In such an aspect, the operating conditions for the reactor can be modified to reduce or mitigate the impact of any defects in the catalyst bed, such as channels or other volumes with different catalyst packing and/or density. For example, the pressure, temperature, space velocity, or another processing condition can be modified to reduce the severity of the reaction in the reactor. This reduced severity can be used during an initial period to determine proper operation of the reactor, or the reduced severity can be maintained for any desired length of operation. As another option, the operator can determine earlier if the run length will be shorter than planned to improve and streamline the plant's scheduling process.

In one embodiment, the catalyst is loaded into the reactor by way of the sock loading method described above. Typically, sock loading is performed with a loading operator inside the reactor, controlling the flow from the sock by throttling the delivery. The operator can move the sock to ensure or provide an even loaded bed growth. The level detection methods described herein would enable direction to be given to the operator to ensure the catalyst load is improved or developed optimally. Without multiple sensors in the reactor, it is difficult for the operator to determine how to load the catalyst in the reactor, as the dusty environment reduces visibility.

Further, when the dense loading method is utilized, as described above, catalyst level checks are typically visual. In some cases, it is difficult and nearly impossible to determine catalyst levels in the reactor that are not directly underneath the manway. There may not be access to the reactor due to obstructions. Also, waiting for dust to settle may take in excess of thirty minutes in some cases, and thus is very inefficient and time consuming. Utilizing methods described herein, visual inspection is unnecessary, as the multiple sensors take the measurements and send them to a computing device, such as a monitoring station for evaluation.

It is believed herein that these methods of invention herein are particularly beneficial in improving reactor catalyst bed flow distributions in two-phase fixed bed reactor vessels. In a two-phase reactor process, the feedstream is a mixture of at least one gas phase component and at least one liquid phase component. Such flowstreams/feedstreams are typical in large hydroprocessing reactors used in the processing of base and intermediate stock hydrocarbon feedstreams in petroleum and petrochemical refineries. These processes include: hydrotreating, hydrodesulfurization, hydrodenitrogenation, hydrodemetalation, hydrogenation, hydroisomerization, hydrocracking, aromatic saturation, olefin saturation processes, and other fixed bed technologies used in chemical reactors. Other processes not involving hydrogen treatment may also be used. In the processes listed above, a hydrocarbon based liquid feedstream is mixed with a hydrogen containing gas stream and then exposed to the catalyst in the reactor vessel to produce an improved product slate. Typically such processes are useful in removing sulfur and other contaminants from hydrocarbon feedstreams (e.g., hydrodesulfurization, hydrodenitrogenation, or hydrodemetalation processes), reducing the average boiling point of hydrocarbon feedstreams (e.g., hydrocracking processes), and/or modifying the hydrocarbon compounds in the hydrocarbon feedstreams (e.g., hydrogenation or hydroisomerization processes). In each of these processes, specific types of catalysts will be utilized depending upon the feedstream composition and the product compositions to be sought.

Preferred hydroprocessing operating conditions for reactor vessels targeted by the methods of invention herein include two-phase flow including one or more of the following conditions: a temperature of at least about 260° C., for example at least about 300° C.; a temperature of about 425° C. or less, for example about 400° C. or less or about 350° C. or less; a liquid hourly space velocity (LHSV) of at least about 0.1 hr⁻¹, for example at least about 0.3 hr⁻¹, at least about 0.5 hr⁻¹, or at least about 1.0 hr⁻¹; an LHSV of about 10.0 hr⁻¹ or less, for example about 5.0 hr⁻¹ or less or about 2.5 hr⁻¹ or less; a hydrogen partial pressure in the reactor from about 200 psig (about 1.4 MPag) to about 3000 psig (about 20.7 MPag), for example about 400 psig (about 2.8 MPag) to about 2000 psig (about 13.8 MPag); a hydrogen to feed ratio (hydrogen treat gas rate) from about 500 scf/bbl (about 85 Nm³/m³) to about 10,000 scf/bbl (about 1700 Nm³/m³), for example from about 1000 scf/bbl (about 170 Nm/m³) to about 5000 scf/bbl (about 850 Nm³/m³).

If the processing conditions within a reactor are modified to reduce or mitigate the impact of a catalyst bed with non-ideal loading, at least one processing condition can be modified to reduce the severity of processing, such as modifying at least one processing condition by about 5%, or by at least about 10%. For example, the partial pressure of hydrogen in the reactor can be reduced by at least about 5% relative to a target hydroprocessing pressure, or by at least about 10%. This can correspond to reducing the hydrogen partial pressure by at least about 10 psi (70 kPa), such as by at least about 20 psi (140 kPa), or by at least about 50 psi (350 kPa), or by at least about 100 psi (700 kPa). Additionally or alternately, the processing temperature can be reduced by at least about 10° C., such as at least about 15° C. or at least about 25° C. To compensate for such lower severity reaction conditions, it can also be desirable to modify the space velocity for feedstock in the reactor so that desired product specifications are maintained.

### Example

The following is a prophetic example of the methods described herein. Prior to loading of a catalyst bed in a reactor, a plurality of sensors can be attached to an interior surface or structure within a reactor, such as by using a temporary support bracket. This allows the plurality of sensors to be removably coupled to the interior surface or structure, such as a fluid distribution plate inside of the reactor. Catalyst loading into a catalyst bed in the reactor can then be initiated using any convenient method, such as the “dense loading” method described above. During catalyst loading, at least one of the multiple sensors in the reactor can detect a variation in the level of the catalyst surface relative to the level detected by one or more other sensors, such as a catalyst level that is higher (or lower) than the measurements at a similar time taken by the other sensors that are monitoring different locations of the catalyst bed. The difference between the measured catalyst level for the at least one sensor and the catalyst level detected by the other sensors can be greater than a threshold value. In response to the high (or low) catalyst level, catalyst loading is adjusted, such as by modifying the angle at which the catalyst is loaded so as to add more catalyst to other areas on the catalyst bed to compensate for the high catalyst level at the location on the catalyst bed where the measurement was taken. Another option can be to reduce the rate of catalyst loading in certain high points and increasing the rate of catalyst loading to the low points. After the catalyst is loaded into the catalyst bed in the reactor, the sensors can be removed from the interior surface or structure. Catalytic processing can then be initiated. Based on a review of the catalyst loading profile at the detected locations during loading, if the loading is determined to be sufficiently uneven for a period of time, a reduced space velocity for the feedstock can initially be used. Depending on the severity of the uneven catalyst loading, the reduced space velocity can be maintained, or the space velocity can be increased to a desired level after an initiation period.

### ADDITIONAL EMBODIMENTS

### Embodiment 1

A method for monitoring catalyst levels during catalyst loading of a catalyst bed in a reactor, the method comprising:
removably coupling a plurality of sensors to an interior structure of a reactor;
during catalyst loading of a catalyst bed in the reactor, detecting catalyst levels in the catalyst bed at multiple locations by the plurality of sensors at substantially a same time;
based on the detected catalyst levels, identifying non-uniformity of a catalyst level in the catalyst bed; and
modifying at least one condition based on the identified non-uniformity, the condition corresponding to a reaction condition for catalytic processing in the reactor, a loading condition for catalyst loading in the reactor, or a combination thereof.

### Embodiment 2

The method of any of the above embodiments, wherein the plurality of sensors detect the catalyst level at the multiple locations at predetermined time intervals.

### Embodiment 3

The method of embodiment 2, further comprising transmitting data from each of the plurality of sensors to a monitoring station after each of the predetermined time intervals so that the data is monitored in real-time.

### Embodiment 4

The method of any of the above embodiments, wherein the at least one reaction condition of the catalytic processing in the reactor comprises a space velocity of feedstock in the reactor, a hydrogen partial pressure in the reactor, an operating temperature of the reactor, or a combination thereof.

### Embodiment 5

The method of any of the above embodiments, wherein the catalytic processing comprises hydroprocessing.

### Embodiment 6

The method of any of the above embodiments, wherein the catalytic processing comprises one of hydrotreating; hydrodesulfurization, hydrodenitrogenation, hydrodemetalation, hydrogenation, hydroisomerization, hydrocracking, aromatic saturation, olefin saturation, or a combination thereof.

### Embodiment 7

The method of any of the above embodiments, wherein the at least one loading condition is a flow rate of the catalyst, an angle at which the catalyst is loaded into the reactor, a position of a catalyst loading device, or a combination thereof.

### Embodiment 8

The method of any of the above embodiments, further comprising generating a catalyst level profile that provides data received from the plurality of sensors over a period of time.

### Embodiment 9

The method of embodiment 8, wherein identifying non-uniformity of a catalyst level in the catalyst bed comprises identifying non-uniformity based on the generated catalyst level profile.

### Embodiment 10

The method of any of the above embodiments, wherein the plurality of sensors are positioned in a linear cross pattern.

### Embodiment 11

The method of any of the above embodiments, wherein the plurality of sensors are positioned in a concentric circular pattern.

### Embodiment 12

The method of any of the above embodiments, wherein at substantially the same time is detecting the catalyst levels in the catalyst bed at the multiple locations by the plurality of sensors at times that differ from each other by less than about one minute.

### Embodiment 13

The method of any of the above embodiments, wherein the sampling interval rate depends upon one or more of a diameter of the reactor, a bed rise rate during the catalyst loading, or a type of formation on the catalyst bed.

### Embodiment 14

The method of any of the above embodiments, wherein the sampling interval rate is less than about 60 samples per minute.

### Embodiment 15

The method of any of the above embodiments, wherein the sampling interval rate is less than about 30 samples per minute.

### Embodiment 16

The method of any of the above embodiments, wherein the sampling interval rate is less than about 15 samples per minute,

### Embodiment 17

A system for detecting catalyst levels during catalyst loading of a catalyst bed in a reactor, the system comprising:

a modular sensor array comprising:
a plurality of sensors for measuring catalyst levels at multiple locations in a catalyst bed in a reactor at substantially a same time and at predetermined time intervals during catalyst loading, each of the plurality of sensors comprising a transceiver for transmitting catalyst level data to a monitoring station; and
a support structure secured to the plurality of sensors, the support structure being removably coupled to an interior structure of the reactor to allow the support structure and the plurality of sensors to be removed from the reactor during catalytic processing.

### Embodiment 18

The system of embodiment 17, wherein the support structure is removably secured to a distribution plate inside of the reactor.

### Embodiment 19

The system of embodiment 17 or 18, wherein the modular sensor array is removably coupled to the interior structure of the reactor during the catalyst loading.

### Embodiment 20

The system of embodiment 17, 18, or 19, wherein the plurality of sensors are one of radar sensors, ultrasonic sensors, sonar sensors, or nuclear sensors.

When numerical lower limits and numerical upper limits are listed herein, ranges from any lower limit to any upper limit are contemplated. While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which the invention pertains.

The present invention has been described above with reference to numerous embodiments. Many variations will suggest themselves to those skilled in this art in light of the above detailed description. All such obvious variations are within the full intended scope of the appended claims.

What is claimed is:

1. A method for monitoring catalyst levels during catalyst loading of a catalyst bed in a reactor, the method comprising:
removably coupling a plurality of sensors to an interior structure of a reactor;
during catalyst loading of a catalyst bed in the reactor, detecting catalyst levels in the catalyst bed at multiple locations by the plurality of sensors at substantially a same time;
based on the detected catalyst levels, identifying non-uniformity of a catalyst level in the catalyst bed; and
modifying at least one condition based on the identified non-uniformity, the condition corresponding to a reaction condition for catalytic processing in the reactor, a loading condition for catalyst loading in the reactor, or a combination thereof.

2. The method of claim 1, wherein the plurality of sensors detect the catalyst level at the multiple locations at predetermined time intervals.

3. The method of claim 2, further comprising transmitting data from each of the plurality of sensors to a monitoring station after each of the predetermined time intervals so that the data is monitored in real-time.

4. The method of claim 1, wherein the at least one reaction condition of the catalytic processing in the reactor comprises a space velocity of feedstock in the reactor, a hydrogen partial pressure in the reactor, an operating temperature of the reactor, or a combination thereof.

5. The method of claim 1, wherein the catalytic processing comprises hydroprocessing.

6. The method of claim 1, wherein the catalytic processing comprises one of hydrotreating, hydrodesulfurization, hydrodenitrogenation, hydrodemetalation, hydrogenation, hydroisomerization, hydrocracking, aromatic saturation, olefin saturation, or a combination thereof.

7. The method of claim 1, wherein the at least one loading condition is a flow rate of the catalyst, an angle at which the catalyst is loaded into the reactor, a position of a catalyst loading device, or a combination thereof.

8. The method of claim 1, further comprising generating a catalyst level profile that provides data received from the plurality of sensors over a period of time.

9. The method of claim 8, wherein identifying non-uniformity of a catalyst level in the catalyst bed comprises identifying non-uniformity based on the generated catalyst level profile.

10. The method of claim 1, wherein the plurality of sensors are positioned in a linear cross pattern or a concentric circular pattern.

11. The method of claim 1, wherein the detection of the catalyst levels in the reactor at the multiple locations does not require operator interaction.

12. The method of claim 1, wherein at substantially the same time is detecting the catalyst levels in the catalyst bed at the multiple locations by the plurality of sensors at times that differ from each other by less than about one minute.

13. The method of claim 1, wherein the sampling interval rate depends upon one or more of a diameter of the reactor, a bed rise rate during the catalyst loading, or a type of formation on the catalyst bed.

14. The method of claim 1, wherein the sampling interval rate is less than about 60 samples per minute.

15. The method of claim 1, wherein the sampling interval rate is less than about 30 samples per minute.

16. The method of claim 1, wherein the sampling interval rate is less than about 15 samples per minute.

17. A system for detecting catalyst levels during catalyst loading of a catalyst bed in a reactor, the system comprising:
a modular sensor array comprising:
a plurality of sensors for measuring catalyst levels at multiple locations in a catalyst bed in a reactor at substantially a same time and at predetermined time intervals during catalyst loading, each of the plurality of sensors comprising a transceiver for transmitting catalyst level data to a monitoring station; and
a support structure secured to the plurality of sensors, the support structure being removably coupled to an interior structure of the reactor to allow the support structure and the plurality of sensors to be removed from the reactor during catalytic processing.

18. The system of claim 17, wherein the support structure is removably secured to a distribution plate inside of the reactor.

19. The system of claim 17, wherein the modular sensor array is removably coupled to the interior structure of the reactor during the catalyst loading.

20. The system of claim 17, wherein the plurality of sensors are one of radar sensors, ultrasonic sensors, sonar sensors, or nuclear sensors.
